(19) United States
(12) Patent Application Publication
(10) Pub. No.: US 2020/0086284 A1
(43) Pub. Date: Mar. 19, 2020

(54) GAS NANOBUBBLES FOR FIRE SUPPRESSION

(71) Applicants: Zvi Yaniv, Austin, TX (US); Shahryar Michael Kiamanesh, Austin, TX (US)

(72) Inventors: Zvi Yaniv, Austin, TX (US); Shahryar Michael Kiamanesh, Austin, TX (US)

(21) Appl. No.: 16/571,523

(22) Filed: Sep. 16, 2019

Related U.S. Application Data
(60) Provisional application No. 62/732,128, filed on Sep. 17, 2018.

(51) Int. Cl. B01F 3/04; A62C 99/00

(52) U.S. Cl. CPC B01F 3/04106; A62C 35/58; A62C 99/0036

(57) ABSTRACT

Fire extinguishing/suppression liquids (with superior fire extinguishing efficacy) use gas nanobubbles in the liquids creating an extinguishing material for fire suppression that can be utilized for any of types of fire suppression applications. The gas nanobubbles may be infused into any type of fire suppression material, which can then be stored in a receptacle for subsequent use by any apparatus, device, or system adapted for delivering such a material to a fire or a location where a fire hazard is imminent.

This application claims priority to U.S. Provisional Patent Application Ser. No. 62/732,128, which is hereby incorporated by reference herein.

### FIELD

The present disclosure is related in general to fire suppression, and in particular, to the incorporation of gas nanobubbles in materials for extinguishing fires.

### BACKGROUND

It is known that many fire extinguishing systems or apparatus utilize liquids and/or gases. The gases are used, sometimes, for just charging or pressure to expel an extinguishing agent. But, the gas itself can also function as a fire suppressing agent. The gases typically utilized are nitrogen, argon, carbon dioxide (CO₂), dry air, and others, or a combination thereof.

It is also understood that a primary extinguishing aspect of the gas or other extinguishing agent is by displacing oxygen in order to starve the fire of oxygen, to cool the fire, and/or breaking the chemical reaction of the fire as outlined in the well-known fire triangle or fire tetrahedron, which is disclosed in Attachment A of the provisional patent application from which this application claims priority. For example, carbon dioxide is utilized in a number of fire suppression systems, be the ones using total flooding and/or portable/handheld extinguishers (e.g., see “Carbon Dioxide as a Fire Suppressant: Examining the Risks,” U.S. EPA, Air and Radiation, (6205J), EPA430-R-00-002, February 2000, 54 pages). For a fire suppression system to work (regardless whether it is implemented as a total flooding system or as a portable/local method), it often requires pressure, which can be provided by pressurizing with gas, such as nitrogen, argon, dry air, or any other gas. With such gaseous pressurized systems, the pressure can be either stored pressure or cartridge based. Or in the case of some sprinkler systems, the pressure can come from water pressure.

The concentration of the fire suppression gas that is included in the extinguishing material can have an important role, and techniques for increasing the concentration of the fire suppression gas in the extinguishing material can be advantageous.

Except for compressed, liquefied, or dissolved gas under pressure, no other methods of increasing the concentration of gas for extinguishing materials are known or applied.

### BRIEF DESCRIPTION OF THE DRAWINGS

FIG. 1 illustrates a hand-held fire extinguisher configured in accordance with embodiments of the present disclosure.

FIG. 2 illustrates a simplified schematic diagram of a fire suppression system configured in accordance with embodiments of the present disclosure.

### DETAILED DESCRIPTION

In this disclosure, the terms “fire extinguishing” and “fire suppression” are used interchangeably. Herein, both of these terms pertain to a material, composition, apparatus, device, system, or method that acts to extinguish, suppress, control, or minimize the spread of flames of a fire.

As referenced herein, the term “liquid” refers to any liquid or fluid of any viscosity, including, but not limited to, water, distilled water, a water solution, oils, a fire suppression material, a foam, a cream, a structural fluid, etc. In this disclosure, the producing, infusing, and generating of gas nanobubbles in a liquid may be used interchangeably. Additionally, such a liquid may be referred to as a “gas nanobubbled liquid.” As referenced herein, the term “nanobubbles” may be used interchangeably with the term “gas nanobubbles.”

Aspects of the present disclosure utilize gas nanobubbles in general, and in certain embodiments, carbon dioxide or nitrogen nanobubbles. Aspects of the present disclosure utilize gas nanobubbles (such as carbon dioxide, argon, nitrogen, helium, dry air, and others) in a liquid for fire suppression applications. Aspects of the present disclosure encompass gas nanobubbles infused into any type of fire suppression material (which may be referred to herein as a “gas nanobubbled fire suppression material”), any receptacle for containing such a material, and/or any apparatus, device, or system for delivering such a material to a fire or a location where a fire hazard is imminent.

Embodiments of the present disclosure provide new fire extinguishing/suppression liquids (with superior fire extinguishing efficacy) using gas nanobubbles in the liquids creating an extinguishing material for fire suppression that can be utilized for any of the types of fire suppression systems disclosed herein and those well-known in the art. In addition, fire extinguishing/suppression agents previously deemed ineffective perhaps because of a poor vaporization rate may now be configured in accordance with embodiments of the present disclosure as a viable fire suppression agent with the addition of gas nanobubbles.

Gas nanobubbles are defined as gas-filled cavities in a liquid (e.g., a water solution) each with a diameter of less than 100 nm. Due to a lack of suitable equipment to produce and measure nanobubbles, some researchers define nanobubbles as bubbles having a diameter of less than 1 micrometer. These nanobubbles generated in a liquid possess several properties such as: (1) minimal to no buoyancy effects, (2) the nanobubble gas/liquid interface is negatively charged, (3) the nanobubbles in the liquid repel each other due to their inherent charge, (4) the nanobubbles avoid coalescence and dissipation, (5) the nanobubbles are stable in a liquid (e.g., for one or more months), (6) the gas nanobubbles in a liquid contribute increased concentration of the dissolved gas in the liquid, (7) the gas nanobubbles (properly generated) exhibit a very high density (e.g., 10⁷-10⁹ bubbles/ml) thus increasing the partial pressure of the gas in the liquid, and (8) due to their nano-diameter sizes, the nanobubbles have a very large interfacial (surface) area. For more information on the foregoing, see, for example, Hideki Tsuge, “Micro- and Nanobubbles: Fundamentals and Applications,” copyright 2014, Pan Stanford Publishing Pte. Ltd., 22 pages; and M Chaplin, “Water Structure and Science,” downloaded from the Internet, 2007 (last updated on Nov. 9, 2017).

Applicants have demonstrated the capability to produce gas nanobubbles in a liquid of less than 250 nanometers in diameter, and even less than 100 nm in diameter, with concentrations of at least 10⁶ nanobubbles/ml, and even 10⁸-10⁹ nanobubbles/ml. For additional information regarding gas nanobubbles and techniques for producing them in a liquid, refer to U.S. provisional application No. 62/551,356; U.S. patent application Ser. No. 16/115,066, U.S. patent application Ser. No. 15/850,362, U.S. provisional application No. 62/490,800, U.S. provisional application No. 62/437,920, U.S. provisional application No. 62/662,832, and U.S. patent application Ser. No. 16/394,430. Furthermore, various embodiments of the present disclosure are described herein in which gas nanobubbles have been produced/generated/infused into a fluid. This can be accomplished utilizing any of the techniques, methods, devices, and systems described in the foregoing patent applications. Note that, in accordance with embodiments of the present disclosure, all liquids, including, but not limited to, water, water solutions, water salt solutions, fluorocarbons, fire suppression materials, Fire Protection Fluids, etc., utilized in the fire extinguishing/suppression industry can be infused with gas nanobubbles (e.g., CO₂, N₂, etc., or a combination thereof).

From the properties of gas nanobubbles in liquids enumerated above, it is obvious that the following properties can have an impact on the quality of a fire suppression material, which, for example, includes, but is not limited to, carbon dioxide or nitrogen nanobubbles (other gases or mixtures thereof as presented above will have similar properties):
1. Long term stability of gas nanobubbles in liquids;
2. Extremely high concentration of gas nanobubbles in a liquid;
3. Gas nanobubbles in a liquid increase substantially the concentration of the dissolved gas in the liquid;
4. Due to their diameter and concentration, gas nanobubbles possess an extremely high surface area per volume;
5. Due to such a high surface area, the evaporation rate of the gas from the nanobubbles will be increased.

As an example, one of the liquids that are utilized in fire suppression is water, and particularly distilled water. For example, with respect to carbon dioxide and water fire extinguishers, the water can be streamed as a liquid or expelled in a mist form (e.g., see the commercially available water mist fire extinguishers from Amerex, Models B270 and B272).

In addition to use in a liquid, in accordance with embodiments of the present disclosure, gas nanobubbles can be produced/generated/infused in the types of foams or other structural fluids that are used for fire suppression, for example, with the various techniques described in the patent applications referenced herein.

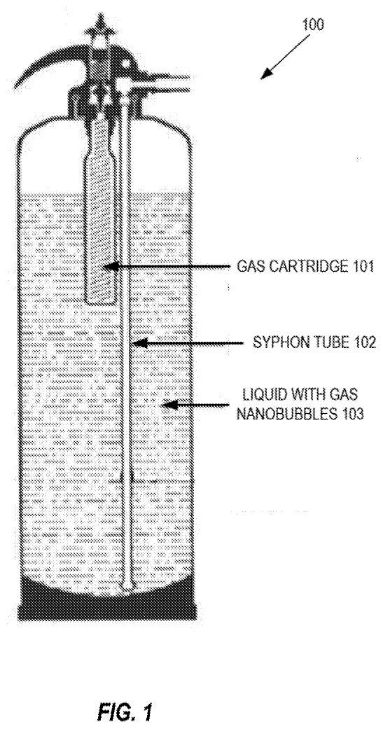

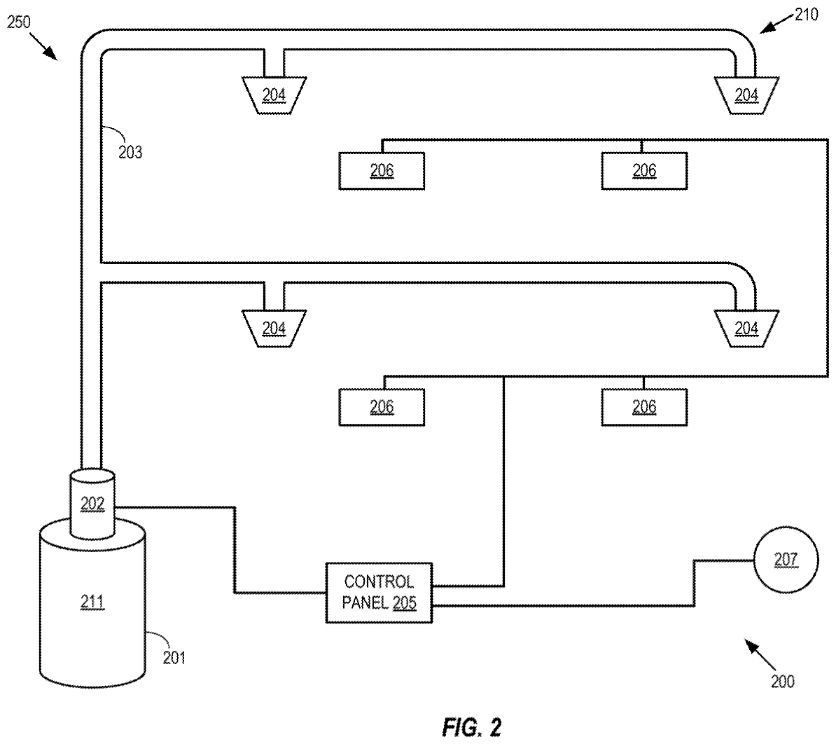

There are several types of fire suppression systems:
1) Portable, mobile, or local application—This includes handheld extinguishers where the user determines where the extinguishing material is directed. For example, see FIG. 1. Mobile applications may include systems for use where industrial equipment is being employed. For example, see the commercially available ANSUL® LVS Liquid Agent Fire Suppression System, which provides both fire suppression and superior cooling of superheated surfaces while blanketing the fuel and cutting off oxygen to help prevent reflash.
2) Total flooding—These can be sprinkler systems or any system whereby the fire suppression material is emitted in large mass to fill a room or space. For example, see FIG. 2. Whether it is a room, a compartment, or a piece of equipment, such a system may be configured to fill it (e.g., from floor to ceiling, and wall to wall) with the fire suppression material so that if the fire is anywhere in that enclosure or in the vicinity of particular equipment it is extinguished.
3) Hybrid total flooding and local application—Combines a local application system and total flooding system, by delivering the agent through nozzles and/or a tubing burst. For example, see FIG. 2.
4) Airborne systems—Such as employed with aircraft to deliver a fire suppression material to a forest fire.

Total flooding and local applications typically utilize some sort of charging system or pressure to be implemented in order to emit the fire suppression material, which may be a mixture of liquid and gas. The gas can be nitrogen, argon, carbon dioxide, dry air, or a combination thereof. In some cases, other gases such as helium may be used.

What such systems emit can range from just inert gases, such as argon or nitrogen, other types of gases (e.g., CO₂), water, or water mixed with various fire suppression chemical agents (chemical agents formulated for fire suppression) or non-aqueous fire suppression chemicals (e.g., a Fire Protection Fluid as disclosed herein). There are a large number of chemical agents that can be used, including, but not limited to FK-5-1-12 (perfluoro(2-methyl-3-pentanone), heptafluoroisopropyl pentafluoroethyl ketone), 2BTP (2-bromotrifluoropropene), and water additive chemicals (e.g., chemicals added to water to enhance its fire extinguishing abilities and/or also combine it with their own unique chemistry), including, but not limited to, the Ansul LVS agent, commercially available from Tyco, which is a wet chemical agent that is a proprietary blend of organic and inorganic salts, coupled with surface active ingredients.

Based on the Baltimore Fire Protection & Equipment (“BFPE”) website (www.bfpe.com), there are at least seven kinds of fire extinguishers. Some are dry, but the majority is wet utilizing water-based fluids or other fluids such as chemicals. As previously disclosed, all liquids/fluids can be infused with gas nanobubbles (for example, utilizing the nanobubblers disclosed in the patent applications referenced herein). As a result, the following types of fire extinguishers can be configured to incorporate embodiments of the present disclosure described herein whereby a fluid, such as a liquid or foam, is infused with gas nanobubbles:
Water and foam fire extinguishers (e.g., those including water and water-based agents, aqueous film-forming foam (“AFFF”), antifreeze, and film-forming fluoroprotein foam (“FFFP”)
Wet chemicals
Water-based fine mist
Halotron (or other fluorocarbon) based
Carbon dioxide based

The equipment utilized for such fire extinguishers can be any commercially available or custom manufactured fire extinguisher, such as those manufactured by Amerex and Ansul.

Referring to FIG. 1, there is illustrated an example of a fire extinguisher 100 utilizing a combination of a liquid extinguishant 103 (e.g., water) and a gas (e.g., CO₂) cartridge 101. Carbon dioxide extinguishers contain a mixture of liquid and gaseous carbon dioxide. Carbon dioxide is normally a gas at room temperature and pressure. It has to be stored under high pressure to make it a liquid. To operate such a typical fire extinguisher, the ring is pulled and the handle pressed, which opens a valve that releases the pressurized gas from the cartridge 101. The gas immediately expands and fills the inside of the extinguisher 100, pushing the liquid 103 downward. As the liquid 103 is pushed down, it rises up the syphon tube 102, and a jet of liquid emerges from the nozzle. Carbon dioxide attacks the fire triangle in two ways: it smothers the oxygen and, when it turns from a liquid back to a gas, it draws in a massive amount of heat from its surroundings (i.e., the latent heat of vaporization), which lowers the temperature of the fire by removing heat.

In accordance with embodiments of the present disclosure, the fire extinguisher 100 is manufactured/filled/charged with a liquid 103 (e.g., water) in which gas (e.g., CO₂) nanobubbles have been infused. This can be accomplished with any of the nanobubblers described within the patent applications previously referenced herein. For example, the liquid 103 is infused with the desired gas nanobubbles using such a nanobubbler, and then stored within the fire extinguisher 100. In such a way, the gas may be delivered by both the gas cartridge and the high concentration of gas nanobubbles infused in the liquid. And, for reasons provided herein, the fire suppression capabilities of such a fire extinguisher are enhanced due to the presence of the gas nanobubbles.

Additionally, in accordance with certain embodiments of the present disclosure, a fire extinguisher (e.g., fire extinguisher 100) can be manufactured using a gas nanobubbled sodium bicarbonate solution in combination with diluted sulfuric acid.

Referring to FIG. 2, there is illustrated a simplified schematic of an exemplary fire suppression system 200. Such a system may include any well-known sprinkler systems implemented within buildings and anything that is emitted in large mass to fill a room or space without any particular intended direction. Whether it is a room or a piece of equipment or compartment, the fire suppression material may be caused to fill it from the floor to ceiling, wall to wall, so that if the fire is anywhere in that room it is extinguished. Such a system may be powered by a pump or local water pressure (not shown in FIG. 2). Generally, there are two types: wet pipe and dry pipe. Wet pipe is when the fire sprinkler pipe is already pre-filled with water under some pressure; so as soon as there is a fire, it is immediately released. The water in this pipe may become brackish over time as it corrodes or goes stale. Nanobubbles infused into the water may be used to prevent this water from going brackish. Also, the nanobubbles can help put out the fire better with this initial release of pressurized water. Dry pipe is when the pipes are left empty under gas pressure; these are often used in places where temperatures fall below freezing, e.g., in parking garages, open warehouses, etc.

The exemplary fire suppression system 200 includes a fire suppression material 211 stored within a receptacle 201, and an apparatus 210 for distributing the fire suppression material 211 from the receptacle 201 to a location in which a fire is to be suppressed and or extinguished. In this particular exemplary schematic diagram, the apparatus 210 for distributing the fire suppression material 211 is configured as a sprinkler system or mist system for distributing the fire suppression material 211 into an enclosed space 250.

The fire suppression system 200 may include a control panel 205 containing the appropriate electrical and/or electronic devices required to receive the sensing of a potential or actual fire from one or more detectors 206, and to signal an apparatus (e.g., a valve) 202 coupled to the receptacle 201 to appropriately expel the fire suppression material 211 through a suitable piping system 203 to one or more discharge nozzles 204. Additionally, one or more notification appliances 207 may be signaled by the control panel 205 to notify occupants of the fire hazard. The schematic diagram of FIG. 2 is merely exemplary, and should not be limiting upon the scope of the types of systems that may be utilized to direct or expel a fire suppression material 211 from a receptacle as needed for a particular application. Nevertheless, in accordance with embodiments of the present disclosure, the fire suppression material 211 may be any of the fire suppression materials disclosed herein in which gas nanobubbles have been infused using any of the nanobubblers described within the patent applications previously incorporated by reference.

Note that any apparatus coupled to the receptacle 201 may be utilized for distribution of the fire suppression material 211 to a space or expelled in any direction. For example, the enclosed space 250 may be an aircraft, an industrial vehicle, a train, etc., and the receptacle 201 may be appropriately selected for storage of the particular fire suppression material 211, while the apparatus coupled to the receptacle 201 may be any suitable device for expelling the fire suppression material 211 from the receptacle 201 in whatever form is appropriate for the application or installation.

Any embodiments of the present disclosure described herein may be configured to utilize a fire suppression material referred to in the industry as a Fire Protection Fluid, which is a fluid that acts like water, looks like water, and flows like water, but does not get things wet in the same way as water. When discharged from a fire apparatus (e.g., a fire suppression system), it converts to a gas, due to its thermodynamic properties and suppresses fire when used at its extinguishing concentration to remove heat. It is often used to extinguish fires as part of automatic fire suppression systems (see FIG. 2), especially in facilities housing electronic equipment, and will not damage electronics in the way that water will. An example of such a Fire Protection Fluid is Novec 1230, FK-5-1-12, C6F12O (commercially available from 3M), which is a fluorinated ketone with the systematic name 1,1,1,2,2,4,5,5,5-nonafluoro-4-(trifluoromethyl)-3-pentanone and the structural formula CF3CF2C(═O)CF(CF3)2, a fully fluorinated analog of ethyl isopropyl ketone. In accordance with embodiments of the present disclosure, such a Fire Protection Fluid may be infused with gas nanobubbles as disclosed herein. The Novec 1230 fluid, or variations thereof, infused with gas nanobubbles may be utilized within a fire suppression system as disclosed with respect to FIG. 2. An example of such a system is the Sapphire system commercially available from Tyco.

Other fire suppression systems that may be configured to utilize a liquid infused with gas nanobubbles include, but are not limited to, the Ansul AquaMist systems, water mist systems, kitchen fire suppression systems, gaseous fire suppression systems, liquid vehicle suppression systems, foam fire suppression systems, clean agent systems, pre-engineered systems with a sensor tube, server rack systems, etc.

Water mist systems are efficient and are considered to be one of the best firefighting alternatives. Water mist systems are particularly suitable in situations where water capacity is limited and collateral damage by water is undesirable (e.g., aircrafts, storage of electric and electronic items, museums, etc.). For example, water delivered as a spray is more effective against hydrocarbon fires than a stream of water. Moreover, it has been found that water is not really very effective in extinguishing a hydrocarbon fire unless that water is delivered to the fire in the form of a mist (very small droplets). Large droplets of water are far less effective, and water in the form of a stream is still less effective. One problem with very small droplets of water is that they do not penetrate through the air easily. Large droplets have less air resistance than small droplets; hence, the large droplets travel more easily through air. But the large droplets can pass through a flame with little evaporation since their surface-to-volume ratio is small. The smaller mist droplets can evaporate easily in a flame, making them more efficient than the larger droplets.

“Water mist” is the generally adopted term for what is considered a form of liquid water for fire suppression in which much smaller water drops are produced than are generally produced by coarse water fire sprinklers. NFPA 750 (a promulgated standard that protects life and property from fire through the standardization of design, installation, maintenance, and testing requirements for water mist fire suppression systems) defines “water mist” as a spray of water in which 99% of the water volume includes water droplets of diameters smaller than 1000 μm. The significantly reduced drop size in a water mist system allows such systems to extinguish flames through high cooling and evaporation rates. The smaller drop size also allows the “water mist” to reach combustion regions not in direct view of the spray devices, since the small droplets have very low momentum and they exhibit gas-like behavior. Thus, they can easily diffuse around obstructions without significant loss of mist due to plating and deposition.

Mechanisms responsible for fire suppression using water mist have been identified as heat extraction or gas phase cooling, oxygen displacement or dilution, and attenuation of radiant heat fluxes. It has been shown that an optimum performance in terms of radiation attenuation is obtained for mists with high flow rate, low droplet diameter, and low velocity.

An advantage of water mist over coarse sprays (e.g., as used in a fire hose or a typical well-known sprinkler system installed in a building) is an increase in the vaporization surface, hence increasing the rate at which water is converted to vapor. In accordance with embodiments of the present disclosure, gas nanobubbles infused into the fire suppression material significantly enhance the fire suppression capabilities of such systems since they will cause the water, water mist, or any liquid, to vaporize more easily, and allow that phase change from liquid to gas to remove heat from the fire.

The gas nanobubbles included in the water mist droplets provide an added fire suppression effect due to the previously described properties pertaining to gas nanobubbles in a liquid. Adding gas nanobubbles into fire suppression/extinguishing systems has an important effect on the physical/chemical processes pertaining to the suppression/extinguishing of a fire, and in particular when the two effects are combined. In the case of fire extinguishing, the two combined effects are heat transfer and evaporation. Both of these processes are inherently transient, but during a short residence time, the effect of vaporization is more prominent, while over a longer resident time, the heat transfer effect is more prominent.

With respect to the utilization of gas nanobubbles in a water mist system, the fire suppression effects pertaining to evaporation are enhanced.

To understand how the gas nanobubbles enhance the fire suppression effects (such as within a water mist system), consider the basic concept of when a liquid is boiled to create liquid vapors. There are three effects in the boiling process: (1) provision of the latent heat of vaporization, (2) raising the temperature of the liquid so that the temperature of the vapor that is in equilibrium also rises, and (3) increase of the gas/liquid in the inter-facial area so as to increase the rate of evaporation.

The addition of gas nanobubbles in the liquid can achieve more vaporization by essentially conducting the foregoing processes far from equilibrium. If d marks density and c marks heat capacity, a liquid (e.g., water) in general will have a very large d×c as compared with a gas, meaning it is possible to heat a gas to higher temperatures than a liquid with the same amount of heat energy. Gas nanobubbles generated in a liquid form a uniform (mono-dispersed) cloud of nanobubbles (recall that the nanobubbles are electrically charged), wherein the mono-dispersion dramatically increases their dispersion within the liquid. This will increase the gas/liquid inter-facial area, and as a result, increase the evaporation rates.

Basically, it is clear that even if a few percent of the heat used for vaporization is going to the gas, more than an order of magnitude increase in vaporization will be achieved than from that same quanta of heat transmitted to the liquid at equilibrium (for example, see W. B. Zimmerman et al., “Towards energy efficient nanobubble generation with fluidic oscillation,” Colloid Interface Sci., vol. 16, no. 4, pp. 350-356, August 2011; W. B. Zimmerman et al., “Microbubble Generation,” Recent Patents on Engineering, vol. 2, no. 1, pp. 1-8, 2008; and W. B. Zimmerman et al., “On the design and simulation of an airlift loop bioreactor with microbubble generation by fluidic oscillation,” Food Bioproducts Process, vol. 87, pp. 215-227, 2009). Consequently, the gas nanobubbles in a liquid will heat faster than the liquid, which correspondingly heats the liquid even faster.

The heat transfer and vaporization properties of gas nanobubbles indicate that the absolute level of humidification is a controllable parameter that depends on the liquid layer depth through which the nanobubble rises through. As a result, the longer the resident time in this layer, the greater the vaporization achieved. Due to the fact that nanobubbles are known to possess an extremely low buoyancy, the residence time of nanobubbles in a liquid is higher (W. B. Zimmerman et al., “Evaporation dynamics of microbubbles,” Chemical Engineering Science, vol. 101, pp. 865-877, May 30, 2013).

Moreover, in the presence of gas nanobubbles, the porous nature of the liquid significantly increases so that the originally properties of the liquid changes. While the density of the liquid changes its fluidity and other properties, the presence or absence of gas nanobubbles influence drastic changes in the properties of the liquid, and in particular its density and temperature variation. Important changes in the liquid properties are density (lower for water), the viscosity in samples with nanobubbles is decreased by about 1.5%, and also the nanobubbles can be cooled from a high temperature to a lower temperature faster than normal water without any external agents.

A result of the foregoing properties associated with gas nanobubbles in a liquid (i.e., increased density of the gas in the liquid, mono-dispersion of the nanobubbles in the liquid, increase in the gas/liquid interfacial area, longer resident time of the gas nanobubbles in the liquid), the vaporization rate of a gas nanobubbled liquid is increased by magnitudes relative to the vaporization rate of the same liquid without gas nanobubbles. Therefore, the inclusion of gas nanobubbles in any liquid utilized for fire suppression/extinguishing will enhance the liquid's capacity to lower the temperature associated with a fire.

Experiments were conducted to determine the enhanced fire suppression effects associated with utilizing gas nanobubbles; in this case, water in which gas nanobubbles of carbon dioxide or nitrogen were generated. As defined herein, a particular fire suppression material has more fire suppression power than another material if it is more effective at lowering the temperature associated with a fire (e.g., lowers the temperature in less time). It was observed in the experiments that water infused with nitrogen nanobubbles had more fire suppression power than water without any gas nanobubbles. It was also observed that water infused with nitrogen nanobubbles had more fire suppression power than water infused with carbon dioxide nanobubbles (e.g., lowering the temperature by as much as 200-300° F. within a same amount of time). It is believed that the water with the carbon dioxide gas nanobubbles did not have as much fire suppression power for the reason being that carbon dioxide is much more soluble in water than nitrogen, and furthermore, the nanobubbles of nitrogen are much smaller (with a resultant larger surface area) than those of carbon dioxide.

Nevertheless, it is thus observed that water containing gas nanobubbles can cool a fire from a higher temperature to a lower temperature faster than water that does not contain gas nanobubbles (assuming no other external agents are present).

It should be noted that various gases may behave differently when combined with certain fire suppression chemical agents, thus affecting their relative fire suppression power.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

It will be understood that particular embodiments described herein are shown by way of illustration and not as limitations of the disclosure. The principal features of this disclosure can be employed in various embodiments without departing from the scope of the disclosure.

All publications and patent applications are herein incorporated by reference to the same extent as if each individual publication or patent application was specifically and individually indicated to be incorporated by reference.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials have been described herein.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

It is contemplated that any embodiment discussed in this specification can be implemented with respect to any method, kit, reagent, or composition of the disclosure, and vice versa. Furthermore, compositions of the disclosure can be used to achieve methods of the disclosure.

While the compositions and methods of this disclosure have been described in terms of described embodiments, it will be apparent to those of skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

The term “or a combination thereof” as used herein refers to all permutations and combinations of the listed items preceding the term. For example, “A, B, C, or a combination thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

What is claimed is:

1. A fire suppression system comprising:
a receptacle containing a liquid infused with gas nanobubbles; and
an apparatus configured to expel the liquid from the receptacle for fire suppression.

2. The fire suppression system as recited in claim 1, wherein the apparatus is a hand-held fire extinguisher.

3. The fire suppression system as recited in claim 1, wherein the apparatus is a fire suppression system comprising:
piping coupled to a valve to the receptacle; and
a control system configured to activate the valve to expel the liquid via the piping into a space.

4. The fire suppression system as recited in claim 3, wherein the control system comprises:
a detector configured to sense an environmental condition within the space indicative of a fire hazard; and
circuitry configured to activate the valve to expel the liquid into the space in response to sensing of the environmental condition by the detector.

5. The fire suppression system as recited in claim 1, wherein the liquid is expelled as a mist.

6. The fire suppression system as recited in claim 1, wherein the liquid is expelled as a foam.

7. The fire suppression system as recited in claim 1, wherein an average diameter of the gas nanobubbles in the liquid is less than 100 nanometers.

8. The fire suppression system as recited in claim 1, wherein the liquid further contains a fire suppression chemical agent.

9. The fire suppression system as recited in claim 1, wherein the liquid is a Fire Protection Fluid.

10. The fire suppression system as recited in claim 1, wherein the gas nanobubbles contain a gas selected from a group consisting of oxygen, air, carbon dioxide, nitrogen, argon, or a combination thereof.

11. A composition comprising a fire suppression material infused with gas nanobubbles.

12. The composition as recited in claim 11, further comprising a chemical agent formulated for fire suppression.

13. The composition as recited in claim 11, wherein the fire suppression material further comprises a chemical agent formulated for fire suppression.

14. The composition as recited in claim 11, wherein the gas nanobubbles contain a gas selected from a group consisting of oxygen, air, carbon dioxide, nitrogen, argon, helium, and a combination thereof.

15. The composition as recited in claim 14, wherein the fire suppression material is selected from a group consisting of water, distilled water, a water solution, oils, a fire suppression material, a foam, a structural fluid, a Fire Protection Fluid, and a combination thereof.

16. The composition as recited in claim 15, wherein a concentration of the gas nanobubbles in the fire suppression material is about ≥10⁶ nanobubbles/ml.

17. A method for fire suppression comprising directing a liquid towards a fire, wherein the liquid has been previously infused with gas nanobubbles.

18. The method as recited in claim 17, wherein the liquid further contains a fire suppression chemical agent.

19. The method as recited in claim 17, wherein the liquid is directed towards the fire as a mist.

20. The method as recited in claim 17, wherein the gas nanobubbles contain a gas selected from a group consisting of oxygen, air, carbon dioxide, nitrogen, argon, helium, and a combination thereof.
